(19) United States
(12) Patent Application Publication
(10) Pub. No.: US 2015/0029437 A1
(43) Pub. Date: Jan. 29, 2015

(54) LIQUID CRYSTAL DISPLAY DEVICE

(71) Applicant: Sharp Kabushiki Kaisha, Osaka-shi, Osaka (JP)

(72) Inventors: Akira Sakai, Osaka-shi (JP); Hisashi Watanabe, Osaka-shi (JP); Yuichi Iyama, Osaka-shi (JP); Akiko Miyazaki, Osaka-shi (JP); Yasushi Asaoka, Osaka-shi (JP); Eiji Satoh, Osaka-shi (JP)

(21) Appl. No.: 14/382,021

(22) PCT Filed: Feb. 26, 2013
(86) PCT No.: PCT/JP2013/054894

§ 371 Date: Aug. 29, 2014

(30) Foreign Application Priority Data
Mar. 1, 2012 (JP) 2012-045871

(51) Int. Cl. G02F 1/1335; G02F 1/13363

(52) U.S. Cl. CPC G02F 1/133606; G02F 1/13363; G02F 2413/13
USPC 349/61

(57) ABSTRACT

A liquid crystal display device that can prevent light leakage in black images, has an improved viewing angle of white images, and can avoid an increase in the thickness and additional costs. The liquid crystal display device includes: a collimating backlight unit; and a liquid crystal display panel. The liquid crystal display panel includes: a pair of substrates; and a liquid crystal layer disposed between the substrates, and the liquid crystal layer includes a polymer dispersed liquid crystal.

### TECHNICAL FIELD

The present invention relates to a liquid crystal display device. More specifically, the present invention relates to a liquid crystal display device having a function of collimating and diffusing light emitted from a backlight unit.

### BACKGROUND ART

Liquid crystal display devices, which are characterized by thin and lightweight designs and low power consumption, are now used in a wide range of applications. General liquid crystal display devices include a backlight (BL) unit that emits light to produce an image, and a liquid crystal display panel that includes a pair of substrates and a liquid crystal layer between the substrates (see, for example, Patent Literature 1). For some applications, reflected sunlight can be used to produce an image. However, a backlight unit including light-emitting light sources is necessary for liquid crystal display devices mainly for indoor applications including word processors, laptop personal computers, and on-vehicle display devices, and liquid crystal display devices for outdoor applications which are required to have constant high brightness.

Known backlight units are generally divided into an edge-light type and a direct type. For liquid crystal display devices with a small-scale screen, backlight units of the edge-light type are widely used because they require fewer light sources and use lower power to produce an image, and are suitable for thin designs.

The backlight units include, besides a light source, a reflective sheet, a diffusing sheet, a prism sheet, a light guide plate, and the like. In an edge-light backlight unit, light emitted from a light source enters a light guide plate from a side face of the light guide plate, and is, for example, reflected and diffused to come out in a plate shape from the main face of the light guide plate. The light further passes through, for example, a prism sheet, and is emitted therefrom to produce an image. In a direct backlight unit, which includes no light guide plate, light emitted from a light source passes through, for example, a diffusing sheet and a prism sheet, and is emitted therefrom to produce an image.

In order to achieve a high contrast ratio, liquid crystal display panels, which control light emitted from a backlight unit (hereinafter, also referred to as backlight unit light), should be configured to prevent light leakage in black images. (Hereinafter, the “contrast ratio” is also referred to as “CR”. The term “CR” refers to a CR in a normal direction to a substrate surface of the liquid crystal display panel, unless otherwise specified.) In the case of commercial liquid crystal display panels provided with linear polarizing plates, their own CR (also referred to as “native CR”) is 3000 to 5000, and in the case of commercial liquid crystal display panels provided with circular polarizing plates, the native CR is 500 to 1500.

By contrast, some of recently developed dimming backlight units that dynamically control the luminance of backlight unit light depending on the brightness of images ensure a CR of more than 10000.

However, the use of a dimming backlight unit may not sufficiently improve the CR depending on images, and may not be effective at all in some cases. In the case of, for example, images including intense black and pure white within a single frame such as images of starry sky, images of a film with subtitles, and images of a black and white checkered pattern, the luminance of light from the backlight unit cannot be reduced in order not to sacrifice the whiteness of white images. This problem can be partially solved by local dimming backlight units that can control the luminance of backlight unit light for each of blocks of a display region independently of other blocks to allow dimming in each block. However, the problem is not completely solved because the same phenomenon occurs within the blocks. Additionally, since the use of a dimming backlight unit leads to higher costs, a current demand is towards liquid crystal display panels with an improved native CR.

### CITATION LIST

### Patent Literature

Patent Literature 1: JP H11-142819 A

### SUMMARY OF INVENTION

### Technical Problem

The following specifically discusses factors relating to improvement in the native CR. Possible reasons of a reduction in the CR are: (i) light leakage due to insufficient performance of polarizing plates; and (ii) light leakage of scattered components of light passing through the inside (a lower substrate, a liquid crystal layer and an upper substrate) of a liquid crystal display panel. Considering that typical polarizing plates used in recent liquid crystal display panels provide a CR of 5000 to 30000, the main reason why liquid crystal display panels have a CR of 500 to 5000 may be the reason (ii).

FIG. 9 is a schematic cross-sectional view illustrating how light leakage occurs in a conventional liquid crystal display panel. A general liquid crystal display panel provided with circular polarizing plates includes a first polarizer 611, a first birefringent layer 612, a color filter substrate 622, a liquid crystal layer 623, a thin film transistor (TFT) substrate 621, a second birefringent layer 614, and a second polarizer 615 in the stated order from the viewer side. The axes of the pair of the first polarizer 611 and the first birefringent layer 612 and the pair of the second polarizer 615 and the second birefringent layer 614 are set such that each pair functions as a circular polarizing plate. As shown in FIG. 9, light that enters the liquid crystal display panel surface in an oblique direction from the back side (the backlight unit side) is modulated into elliptically polarized light (a) when passing through the circular polarizing plate on the back side. The elliptically-polarized light (a) is then scattered when passing through the TFT substrate 621, and a component (b) thereof proceeds in the direction perpendicular to the substrate surface. The component (b) passes through the liquid crystal layer 623 and the color filter substrate 622 without a change in its polarization state, and then passes through the circular polarizing plate on the viewer side in the elliptically-polarized state so that a part of the component is not blocked and is emitted as a leak light component (c) to the outside. The quantity of such light leakage depends on the ellipticity of elliptically-polarized light at the time of passing through the latter circular polarizing plate. Even if oblique incident light proceeds straight through the TFT substrate 621, the same phenomenon occurs when the light passes through the color filter substrate 622 as shown in FIG. 9.

As described above, a cause of light leakage is that the light path of light that enters the liquid crystal display panel in an oblique direction to the panel surface is changed by internal scattering to the normal direction, and the light is not completely blocked by the circular polarizing plate on the viewer side. Such light leakage can be reduced by employing a collimating backlight unit that emits parallel light (i.e., a backlight unit that emits light in the normal direction to the liquid crystal display panel surface) instead of a backlight unit that emits diffused light (i.e., a backlight unit that emits light in an oblique direction to the liquid crystal display panel surface).

However, this strategy has a disadvantage that white images look dark when viewed in an oblique direction although light leakage in black images can be reduced. One possible solution to this may be to employ a so-called collimating/diffusing system, which further includes a diffusing element externally disposed on the viewer side surface of the liquid crystal display panel. Unfortunately, this strategy increases the thickness of the whole liquid crystal display panel and requires additional costs. In addition, the diffusing element externally disposed on the viewer side of the liquid crystal display panel may cause light leakage when backlight unit light is not completely parallel, and thus may be a cause of inhibiting the effect of reducing light leakage.

The present invention was made in view of the background, and an object of the present invention is to provide a liquid crystal display device that can prevent light leakage in black images, has an improved viewing angle of white images, and can avoid an increase in the thickness and additional costs.

### Solution to Problem

The present inventors have studied various means to achieve prevention of light leakage in black images; improvement in the viewing angle of white images, and prevention of an increase in the thickness and additional costs at the same time, and found that the above object can be achieved by a liquid crystal display panel configured to function as a diffusing element as well, and configured such that the degree of the diffusing function can be actively controlled. Specifically, the present inventors have found that a liquid crystal display device configured such that collimated backlight unit light enters a diffusing element having an active diffusing function of diffusing light to a smaller degree for black images and diffusing light to a greater degree for white images can prevent light leakage in black images, and thereby has an improved CR, and displays white images with sufficient brightness even when viewed in an oblique direction. Another finding is that a liquid crystal display panel of a polymer dispersed liquid crystal (PDLC) type can be used as the diffusing element capable of actively controlling the degree of diffusion of light to easily function as both a diffusing element and a liquid crystal display panel, and to prevent an increase in the thickness and additional costs.

Specifically, one aspect of the present invention is a liquid crystal display device that includes: a collimating backlight unit; and a liquid crystal display panel, the liquid crystal display panel including: a pair of substrates; and a liquid crystal layer between the substrates, the liquid crystal layer including polymer dispersed liquid crystal.

The term “collimating backlight unit” herein refers to a backlight unit in which a member having collimating properties (hereinafter, also referred to as collimating element) is added to a general backlight unit. The collimating element may be apart of the backlight unit or may be independent of the backlight unit. Specifically, the collimating backlight unit may be a laminate of the collimating element and the backlight unit, or may be a backlight unit including the collimating element therein and having a collimating function. Light leakage in black images can be remarkably reduced by collimating backlight unit light once.

The term “polymer dispersed liquid crystal (PDLC)” herein refers to a composite containing nematic liquid crystal and polymers in which microparticles of liquid crystal are dispersed in a polymer matrix, and such a composite has light scattering effects to allow for control of scattering and transmission of light. The liquid crystal display panel including a liquid crystal layer made of such a material, which allows for integration of a diffusing element and a liquid crystal element, remarkably contributes to a decrease in the thickness and eliminates additional costs. The liquid crystal panel is very suitable for improving both the CR in terms of black images and the viewing angle of white images because it allows for application of a voltage to each pixel region of the liquid crystal layer, and therefore allows for control of the degree of diffusion of light passing through the liquid crystal layer for each pixel.

The structure of the liquid crystal display device is not particularly limited by other members provided that it includes the above-described essential members.

The following demonstrates preferable embodiments of the liquid crystal display panel in detail. Combinations of two or more of the following preferable embodiments should also be considered as preferable embodiments of the liquid crystal display panel.

Each of the substrates preferably includes an alignment film on a surface facing the liquid crystal layer. Although the polymer dispersed liquid crystal (PDLC) type may not include an alignment film, the use of alignment films further improves the CR, and namely can produce more efficient CR improving effects when combined with the above-described features of the present inventions.

Each of the substrates preferably includes a polarizing plate on the surface opposite to the surface facing the liquid crystal layer. Although the polymer dispersed liquid crystal (PDLC) type may not include a polarizing plate, the use of polarizing plates further improves the CR, and namely can produce more efficient CR improving effects when combined with the above-described features of the present inventions.

In one preferable embodiment, one of the polarizing plates includes a first polarizer, and the other includes a second polarizer. In the preferable embodiment, a first birefringent layer is disposed between the first polarizer and the liquid crystal display panel, and a second birefringent layer is disposed between the liquid crystal display panel and the second polarizer. Both the first birefringent layer and the second birefringent layer preferably have a biaxial parameter NZ of not less than 1. In the case where the first and second birefringent layers are present, the pair of the first polarizer and the first birefringent layer and the pair of the second polarizer and the second birefringent layer each function as a circular polarizing plate. The PDLC type used in the present invention, which is a so-called random alignment type, maximizes the transmittance when used in combination with a circular polarizing plate.

In the preferable embodiment, a third birefringent layer is further disposed between the first polarizer and the first birefringent layer. The third birefringent layer preferably has a biaxial parameter NZ of not more than 0. The third birefringent layer is disposed to further improve the CR even when the collimating backlight unit cannot collimate light completely.

### Advantageous Effects of Invention

The present invention provides a liquid crystal display device that can prevent light leakage in black images, has an improved viewing angle of white images, and can avoid an increase in the thickness and additional costs.

### BRIEF DESCRIPTION OF DRAWINGS

FIG. 1 is a schematic view illustrating the layer structure of a liquid crystal display device of Embodiment 1.

FIG. 2 is a schematic view illustrating the layer structure of a liquid crystal display device of Embodiment 2.

FIG. 3 is a schematic view illustrating the layer structure of liquid crystal display devices of Examples 1 and 2.

FIG. 4 is a schematic view illustrating the layer structure of liquid crystal display devices of Examples 3 and 4.

FIG. 5 is a schematic view illustrating the layer structure of a liquid crystal display device of Comparative Example 1.

FIG. 6 is a schematic view illustrating the layer structure of a liquid crystal display device of Comparative Example 2.

FIG. 7 is a schematic view illustrating the layer structure of a liquid crystal display device of Comparative Example 3.

FIG. 8 is a table comparing the layer structure of the present invention and conventional layer structures and summarizing the difference of performances between them.

FIG. 9 is a schematic cross-sectional view illustrating how light leakage occurs in a conventional liquid crystal display panel.

### DESCRIPTION OF EMBODIMENTS

The following terms are defined herein as mentioned below.

The term “polarizer” herein refers to an element having a function of providing a component vibrating only in a specific direction (linearly polarized light) from unpolarized light (natural light), partially polarized light, or linearly polarized light. The term “polarizer” used herein means only an element having a function of polarizing light and including no protection film, unless otherwise specified. The term “polarization axis” of a polarizer refers to the “absorption axis” in the case of an absorptive polarizer, and to the “reflection axis” in the case of a reflective polarizer.

The term “in-plane retardation R” is defined by the equation R=(ns−nf)×d. The term “thickness direction retardation Rth” is defined by the equation Rth=(nz−(nx+ny)/2)×d. The term “biaxial parameter NZ” is defined by the equation NZ=(ns−nz)/(ns−nf). In the equations, nx and ny are the principal refraction indices in the in-plane direction, nz is the principal refraction index in the out-of-plane direction, that is, the principal refraction index in the direction perpendicular to the birefringent layer surface, ns is a larger one of the refractive indices nx and ny, nf is a smaller one of the refractive indices nx and ny, and d is the thickness of the birefringent layer. Unless otherwise specified, optical parameters, such as the main refractive indices, retardations, and Nz, are measured at a wavelength of 550 nm herein.

The term “birefringent layer” refers to a layer having optical anisotropy, and specifically to a layer, at least one of the absolute values of the in-plane retardation R and thickness direction retardation Rth of which is not less than 10 nm. This term is synonymous with “retardation film”. Herein, a birefringent layer (retardation film) having an NZ 1 is referred to as a first-type birefringent layer, and a birefringent layer (retardation film) having an NZ 0 is referred to as a second-type birefringent layer.

The term “axis angle” refers to the polarization axis (absorption axis or reflection axis) in the case of a polarizer, and to the slow axis in the case of a birefringent layer, unless otherwise specified.

The following embodiments are provided to demonstrate the present invention in more detail based on drawings, and are not intended to limit the present invention.

### Embodiment 1

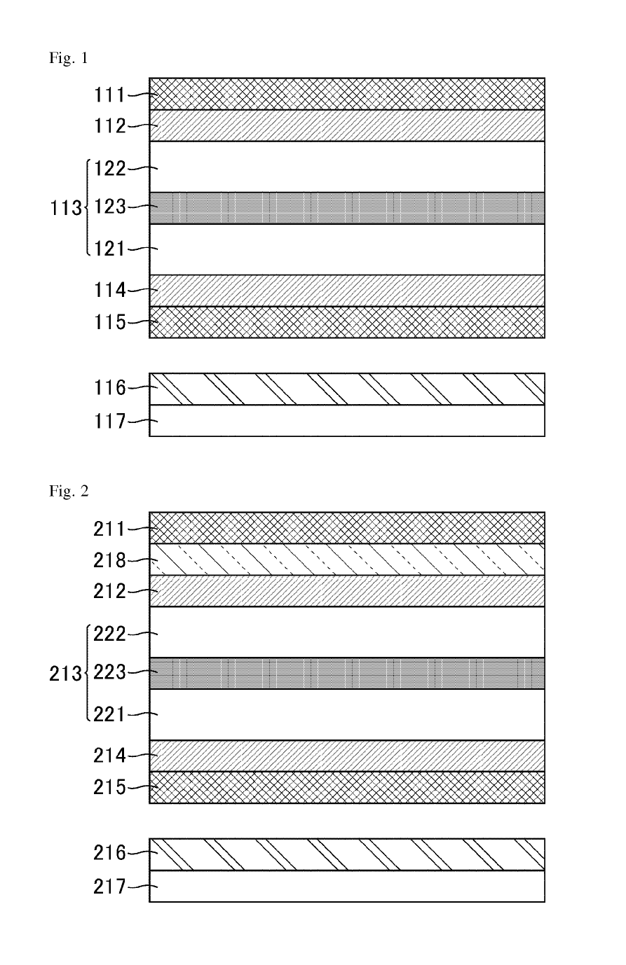

FIG. 1 is a schematic view illustrating the layer structure of a liquid crystal display device of Embodiment 1. The liquid crystal display device of Embodiment 1 is, as shown in FIG. 1, a liquid crystal display device including a laminate consisting of a first polarizer 111, a first birefringent layer (a first-type birefringent layer) 112, a liquid crystal display panel (the PDLC type) 113, a second birefringent layer (a first-type birefringent layer) 114, a second polarizer 115, a collimating element 116, and a backlight unit 117 in the stated order from the viewer side. The liquid crystal display panel 113 includes a pair of substrates: a TFT substrate 121 and a color filter substrate 122, and a liquid crystal layer 123 between the substrates 121 and 122. The liquid crystal layer 123 is made of polymer dispersed liquid crystal (PDLC).

The first polarizer 111 and the second polarizer 115 are arranged such that their polarization axes are perpendicular to each other (in crossed Nicols). More specifically, the polarization axes of the first polarizer 111 and the second polarizer 115 form an angle within the range of 90±2° (preferably 90±1°). The first polarizer 111 and the second polarizer 115 may be arranged such that their polarization axes are parallel to each other (in parallel Nicols), but the crossed Nicols arrangement is preferable in terms of achieving a high CR.

The first birefringent layer 112 and the second birefringent layer 114 belong to the category “first-type birefringent layers”, and meet the requirement NZ≧1. Preferably, they have an NZ of not less than 1.5. This increases the viewing angle of the liquid crystal display panel itself and further contributes to an effect of improving the CR.

Although in the example shown in FIG. 1, both the first birefringent layer 112 and the second birefringent layer 114 consist of a single birefringent layer, the first birefringent layer 112 and the second birefringent layer 114 may include a plurality of birefringent layers. For example, a laminate consisting of three birefringent layers may be used to function as a birefringent layer as a whole.

The following demonstrates members of the liquid crystal display device of Embodiment 1 in detail.

### (Birefringent Layer)

Any material and any production method can be used without particular limitation for the birefringent layers used in Embodiment 1. For example, stretched polymer films, liquid crystalline materials whose alignment is fixed, or thin plates made of an inorganic material may be used. Any method for forming the birefringent layers can be used without particular limitation. In the case where a polymer film is used as a birefringent layer, solvent casting and melt extrusion can be used, for example. Or, coextrusion may be used to produce a plurality of birefringent layers at one time. The film may not be stretched or may be appropriately stretched as long as it has a desired retardation. Stretching of the film may be accomplished by any method without particular limitation, for example, by tensile stretching between rolls, compression stretching between rolls, lateral uniaxial stretching with a tenter, stretching in an oblique direction, lateral and longitudinal biaxial stretching, and special stretching under the contractile force of a heat-shrinkable film. In the case of a birefringent layer made of a liquid crystalline material, a method involving applying a liquid crystalline material to an alignment-treated base film, and fixing the alignment can be used. Or, the layer may be formed by using a base film on which a special alignment treatment is not performed, or by removing a layer from a base film after fixing the alignment, and transferring the layer to another film as long as the layer has a desired retardation. Alternatively, the alignment of liquid crystalline material may not be fixed. The same methods for a birefringent layer made of a liquid crystalline material may be employed for a birefringent layer made of a non-crystalline material as well.

### (First-Type Birefringent Layer)

As the first-type birefringent layers, stretched films including a material with positive intrinsic birefringence can be appropriately used. Examples of materials with positive intrinsic birefringence include polycarbonate, polysulfone, polyether sulfone, polyethylene terephthalate, polyethylene, polyvinyl alcohol, norbornene, triacetyl cellulose, and diacetyl cellulose.

### (Polarizer)

Any type of polarizer can be used without particular limitation in Embodiment 1. For example, an absorption-type polarizer consisting of a polyvinyl alcohol (PVA) film with an anisotropic material, such as a dichroic iodine complex, aligned and adsorbed thereon or a reflection-type polarizer (e.g. DBEF from 3M) obtained by uniaxial stretching of a film made by coextrusion of two types of resin may be appropriately used. Or, a laminate including an absorption-type polarizer and a reflection-type polarizer may be used.

### (Collimating Element)

Any type of collimating element can be used without particular limitation in Embodiment 1. For example, a prism film (BEF film from 3M) or a light control film (louver film from 3M) may be used. The collimating element may consist of a plurality of elements. The collimating element may be provided in the inside of the backlight unit. The collimating element may be an element that anisotropically collimates light to inhibit, together with the polarizers and the birefringent layers, incident light in an oblique direction at a specific azimuth in which significant light leakage occurs.

### (Liquid Crystal Display Panel)

The liquid crystal display panel of Embodiment 1 is a PDLC-type liquid crystal display panel that functions as a diffusing element as well. The PDLC-type liquid crystal display panel can be produced, for example, by sealing a mixture obtained by compatibly dissolving a nematic liquid crystal material (i.e. a low-molecular-weight liquid crystal composition) and a photocurable resin (monomer and/or oligomer) between the substrates, and exposing the mixture to light to polymerize the photocurable resin. Any type of photocurable resin can be used without particular limitation, but an ultraviolet (UV) curable resin is preferable. A UV curable resin can be polymerized without heating the mixture. This eliminates adverse influence due to heat on other members. The monomer and oligomer may be monofunctional or polyfunctional. In general, PDLC-type liquid crystal display devices do not need alignment-treated alignment films and polarizing plates. The PDLC-type devices can produce images without polarizing plates and alignment films because the optical state is changed from the scattered state to the transmitted state or vice versa by applying a voltage to the liquid crystal layer. By contrast, the present embodiment uses alignment-treated alignment films and polarizing plates although the same material as that conventionally used for PDLC is used. This allows for the production of images with higher contrast. In the present embodiment, the alignment films may be vertical alignment films or horizontal alignment films. In the case of vertical alignment films, a negative liquid crystal material and perpendicular polarizing plates (a pair of polarizing plates, the polarization axes of which are perpendicular to each other) are used together to produce a black image while no voltage is applied, and to produce a white image while a voltage is applied to lay liquid crystal molecules in various azimuths and to scatter light. In this case, the liquid crystal display device is of a normally black mode. On the other hand, in the case where horizontal alignment films are used in combination with a positive liquid crystal material and perpendicular polarizing plates without performing a conventional rubbing step, liquid crystal molecules are aligned horizontally to the substrate surfaces in various azimuths and scatter light to produce a white image while a voltage is applied, and liquid crystal molecules are aligned vertically without scattering light to produce a black image while no voltage is applied. In this case, the liquid crystal display device is of a normally white mode. The polarizing plates attached to the respective surfaces of the liquid crystal display panel may be linear polarizing plates or may be circular polarizing plates. Since the liquid crystal display panel of the present embodiment is of a so-called random alignment type that aligns liquid crystal molecules in various azimuths to produce a white image, circular polarizing plates are used as the polarizing plates to maximize the transmittance. The structures of the circular polarizing plates are not particularly limited, and wide viewing angle-type circular polarizing plates may be used.

### (Backlight Unit)

Any type of backlight unit can be used without particular limitation in Embodiment 1. A backlight unit including at least a light source such as a cold cathode fluorescent lamp (CCFL), a hot cathode fluorescent lamp (HCFL), or a light emitting diode (LED) may be appropriately used. The unit is preferably provided with a diffusing layer such as a diffusing plate or a diffusing sheet to diffuse spot light or linear light emitted from the light source into a uniform plane shape. Since the liquid crystal display device of Embodiment 1 is provided with a collimating element that collimates light before the light enters the liquid crystal display panel, the backlight unit may not necessarily have a collimating function. However, the backlight unit may include an optical sheet having a collimating function, such as a lens sheet or a prism sheet.

### Embodiment 2

The liquid crystal display device of Embodiment 2 is the same as the liquid crystal display device of Embodiment 1, except that a third birefringent layer is disposed between the first polarizer and the first birefringent layer, so that the polarizing plates function as a wide viewing angle polarizing plate. The third birefringent layer belongs to the category “second-type birefringent layers”.

FIG. 2 is a schematic view illustrating the layer structure of a liquid crystal display device of Embodiment 2. The liquid crystal display device of Embodiment 2 is, as shown in FIG. 2, a liquid crystal display device including a laminate consisting of a first polarizer 211, a third birefringent layer (a second-type birefringent layer) 218, a first birefringent layer (a first-type birefringent layer) 212, a liquid crystal display panel (the PDLC type) 213, a second birefringent layer (a first-type birefringent layer) 214, a second polarizer 215, a collimating element 216, and a backlight unit 217 in the stated order from the viewer side. The liquid crystal display panel 213 includes a pair of substrates: a TFT substrate 221 and a color filter substrate 222, and a liquid crystal layer 223 between the substrates 221 and 222. The liquid crystal layer 223 is made of polymer dispersed liquid crystal (PDLC).

### (Second-Type Birefringent Layer)

A second-type birefringent layer can be suitably obtained by stretching a film containing a material with negative intrinsic birefringence, or by stretching a film containing a material with positive intrinsic birefringence under action of a shrinkage force of a heat-shrinkable film. In terms of the simplicity of the procedure for production, a stretched film containing a material with negative intrinsic birefringence is preferably used among others. For example, a resin composition including acrylic resin and styrene resin, polystyrene, polyvinyl naphthalene, polyvinyl biphenyl, polyvinyl pyridine, polymethyl methacrylate, polymethyl acrylate, N-substituted maleimide copolymer, polycarbonate having a fluorine skeleton, or triacetyl cellulose (particularly having a small acelylation degree) can be mentioned as the material with negative intrinsic birefringence. In terms of optical properties, productivity, and heat resistance, a resin composition including acrylic resin and styrene resin is preferable among others.

The liquid crystal display device of the present invention may include additional birefringent layers besides the birefringent layers described in Embodiment 1 and Embodiment 2. Such a structure is also another embodiment of the present invention.

### Evaluation Test

The following shows the results of evaluation of properties of the liquid crystal display devices of Embodiments 1 and 2. The backlight unit used in a liquid crystal television (LC40-SE1) from Sharp Corporation was used in the following examples and comparative examples, unless otherwise specified. The backlight unit is a laminate consisting of a LED light source, a diffusing plate, a diffusing sheet and a lens sheet in the stated order.

### EXAMPLES 1 AND 2

In Examples 1 and 2, the liquid crystal display device of Embodiment 1 was actually produced. The only difference between Examples 1 and 2 is the initial alignment of PDLC. In Example 1, a normally black-mode liquid crystal display device with vertical alignment films was produced, and in Example 2, a normally white-mode liquid crystal display device with horizontal alignment films was produced.

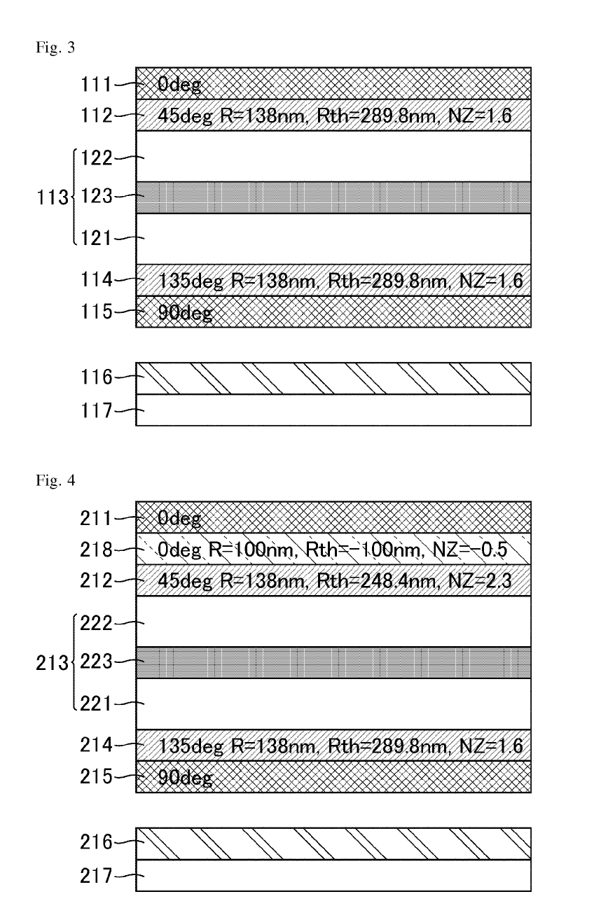

FIG. 3 is a schematic view illustrating the layer structure of the liquid crystal display devices of Examples 1 and 2. As shown in FIG. 3, the axis angle of the first polarizer 111 was 0°, and the axis angle of the second polarizer 115 was 90°. The axis angle of the first birefringent layer (the first-type birefringent layer) 112 was 45°, and the axis angle of the second birefringent layer (the first-type birefringent layer) 114 was 135°. The first birefringent layer had an in-plane retardation R of 138 nm, a thickness direction retardation Rth of 289.8 nm, and an NZ coefficient of 1.6. The second birefringent layer had an in-plane retardation R of 138 nm, a thickness direction retardation Rth of 289.8 nm, and an NZ coefficient of 1.6.

The TFT substrate 121 and the color filter substrate 122 each have an alignment film (a vertical or horizontal alignment film).

The backlight unit 117 and the collimating element 116 were independent members. In Examples 1 and 2, the collimating element was a laminate consisting of two louver films (from 3M).

### EXAMPLES 3 AND 4

In Examples 3 and 4, the liquid crystal display device of Embodiment 2 was actually produced. The only difference between Examples 3 and 4 is the initial alignment of PDLC. In Example 3, a normally black-mode liquid crystal display device with vertical alignment films was produced, and in Example 4, a normally white-mode liquid crystal display device with horizontal alignment films was produced.

FIG. 4 is a schematic view illustrating the layer structure of liquid crystal display devices of Examples 3 and 4. As shown in FIG. 4, the axis angle of the first polarizer 211 was 0°, and the axis angle of the second polarizer 215 was 90°. The axis angle of the first birefringent layer (the first-type birefringent layer) 212 was 45°, the axis angle of the second birefringent layer (the first-type birefringent layer) 214 was 135°, and the axis angle of the third birefringent layer (the second-type birefringent layer) 218 was 0°. The first birefringent layer had an in-plane retardation R of 138 nm, a thickness direction retardation Rth of 248.4 nm, and an NZ coefficient of 2.3. The second birefringent layer had an in-plane retardation R of 138 nm, a thickness direction retardation Rth of 289.8 nm, and an NZ coefficient of 1.6. The third birefringent layer had an in-plane retardation R of 100 nm, a thickness direction retardation Rth of −100 nm, and an NZ coefficient of −0.5.

The liquid crystal display devices of Examples 1 and 2, which were of a collimating/diffusing type, namely had both a collimating function and a scattering function, had an improved CR in the normal direction. However, in the case where backlight unit light is not collimated completely, additional alterations are preferably made to the polarizing plates to increase the viewing angle of the liquid crystal display panel itself. This is based on the fact that the collimating/diffusing type changes the proceeding direction of a part of light passing through the liquid crystal in an oblique direction to the normal direction by diffusion, and the use of polarizing plates (a liquid crystal display panel) with a narrow viewing angle tends not to result in high CR in the normal direction. The use of the second-type birefringent layer reduces this tendency.

The backlight unit and the collimating element were independent members. In Examples 3 and 4, the collimating element was a laminate consisting of two louver films (from 3M).

### COMPARATIVE EXAMPLE 1

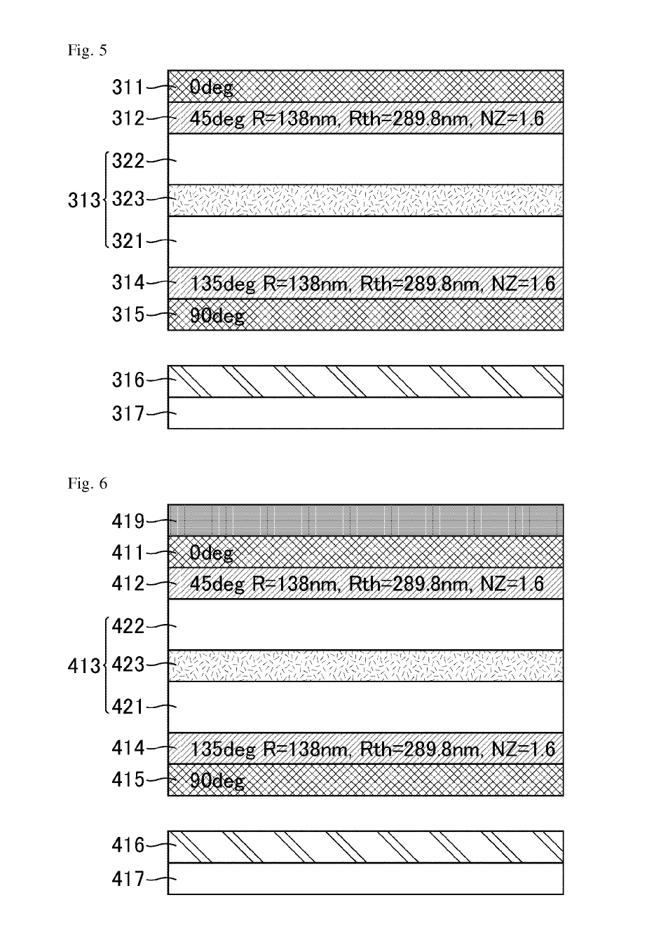

FIG. 5 is a schematic view illustrating the layer structure of a liquid crystal display device of Comparative Example 1. The liquid crystal display device of Comparative Example 1 was produced in the same manner as in Example 1, except that a VA-type liquid crystal display panel was used instead of the PDLC-type liquid crystal display panel. Specifically, the liquid crystal display device of Comparative Example 1 was, as shown in FIG. 5, a liquid crystal display device including a laminate consisting of a first polarizer 311, a first birefringent layer (a first-type birefringent layer) 312, a liquid crystal display panel (the VA type) 313, a second birefringent layer (a first-type birefringent layer) 314, a second polarizer 315, a collimating element 316, and a backlight unit 317 in the stated order from the viewer side. The liquid crystal display panel 313 included a pair of substrates: a TFT substrate 321 and a color filter substrate 322, and a liquid crystal layer 323 between the substrates 321 and 322. The axis angles and retardations of the polarizers and the birefringent layers were the same as those of Example 1.

### COMPARATIVE EXAMPLE 2

FIG. 6 is a schematic view illustrating the layer structure of a liquid crystal display device of Comparative Example 2. The liquid crystal display device of Comparative Example 2 was produced in the same manner as in Comparative Example 1, except that a high diffusion film was further provided on the viewer side of the first polarizer. Specifically, the liquid crystal display device of Comparative Example 2 was, as shown in FIG. 6, a liquid crystal display device including a laminate consisting of a diffusion film 419, a first polarizer 411, a first birefringent layer (a first-type birefringent layer) 412, a liquid crystal display panel (the VA type) 413, a second birefringent layer (a first-type birefringent layer) 414, a second polarizer 415, a collimating element 416, and a backlight unit 417 in the stated order from the viewer side. The liquid crystal display panel 413 included a pair of substrates: a TFT substrate 421 and a color filter substrate 422, and a liquid crystal layer 423 between the substrates 421 and 422. The axis angles and retardations of the polarizers and the birefringent layers were the same as those of Example 1. In Comparative Example 2, the diffusion film 419 was a diffusing sheet having a haze of 85%, which is widely used as a backlight unit sheet, and was adhered to the first polarizer 411 with a transparent optical adhesive. The total thickness of the diffusing sheet and the adhesive was approximately 105 μm.

### COMPARATIVE EXAMPLE 3

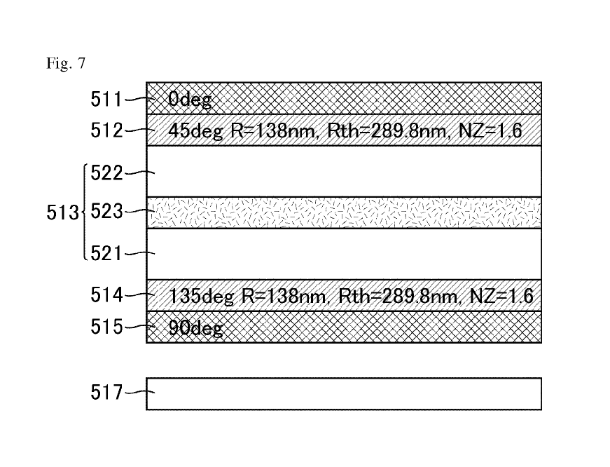

FIG. 7 is a schematic view illustrating the layer structure of a liquid crystal display device of Comparative Example 3. The liquid crystal display device of Comparative Example 3 was produced in the same manner as in Comparative Example 1, except that no collimating element was provided. Specifically, the liquid crystal display device of Comparative Example 3 was, as shown in FIG. 7, a liquid crystal display device including a laminate consisting of a first polarizer 511, a first birefringent layer (a first-type birefringent layer) 512, a liquid crystal display panel (the VA type) 513, a second birefringent layer (a first-type birefringent layer) 514, a second polarizer 515, and a backlight unit 517 in the stated order from the viewer side. The liquid crystal display panel 513 included a pair of substrates: a TFT substrate 521 and a color filter substrate 522, and a liquid crystal layer 523 between the substrates 521 and 522. The axis angles and retardations of the polarizers and the birefringent layers were the same as those of Example 1.

The liquid crystal display devices actually produced in Examples 1 to 4 and Comparative Examples 1 to 3 were evaluated for the CR in the normal direction (the CR measured in the normal direction) and white image viewing angle (the luminance of a white image measured in an oblique direction).

### (How to Measure CR in Normal Direction)

A super-low luminance spectroradiometer (SR-U11 from TOPCON) was used for the measurement. The luminance (white luminance) of a white image and the luminance (black luminance) of a black image were measured in the normal direction, and the ratio thereof was calculated as CR.

### (How to Measure Luminance of White Image in Oblique Direction)

A viewing angle measurement device (EZContrast 160 from ELDIM) was used for the measurement. The white image was measured for the luminance L (45, 60) in the oblique direction with an azimuth angle of 45° and an inclination angle of 60° and the luminance L (0, 0) in the normal direction. A large ratio of the luminances corresponds to higher luminance of an image viewed in an oblique direction and thus a larger viewing angle of white images.

### (Evaluation Result)

The liquid crystal display devices of the examples and the comparative examples were evaluated for the CR in the normal direction and the white image viewing angle, and the results are summarized in Table 1. The liquid crystal display devices of Examples 1 to 4 had a higher CR than the liquid crystal display devices of Comparative Examples 2 and 3, and had a better viewing angle of a white image than Comparative Example 1. Additionally, unlike Comparative Example 2 in which a high diffusion film was disposed on the viewer side of the polarizer on the viewer side, the liquid crystal display panels were thinner.

TABLE 1

| | | | White image | | |
|---|---|---|---|---|---|
| | | | viewing angle | | |
| | CR in normal direction | | L (45, 60)/L (0, 0) | | Thickness |
| Example 1 | 3240 | ++ | 0.20 | + | + |
| Example 2 | 3010 | ++ | 0.22 | + | + |
| Example 3 | 3420 | ++ | 0.20 | + | + |
| Example 4 | 3180 | ++ | 0.22 | + | + |
| Comparative | 3550 | ++ | 0.07 | − | + |
| Example 1 | | | | | |
| Comparative | 2560 | + | 0.19 | + | − |
| Example 2 | | | | | |
| Comparataive | 1320 | ± | 0.21 | + | ++ |
| Example 3 | | | | | |

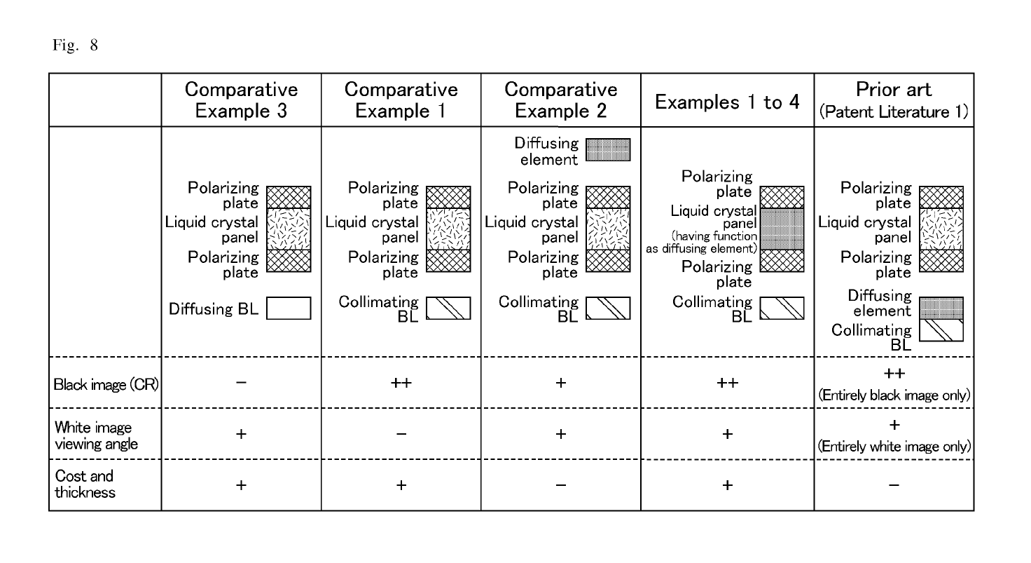

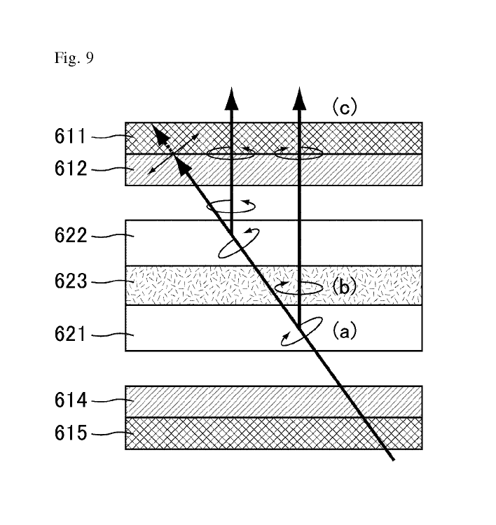

FIG. 8 is a table comparing the layer structure of the present invention and the conventional layer structures and summarizing the difference of performances between them based on the above-mentioned results. It is revealed that Comparative Examples 1 to 3 have a good score in any of the CR in the normal direction, the viewing angle of a white image, the whole thickness, and the like, but in order to achieve good scores in all of these properties, the structures of Examples 1 to 4 are necessary.

The liquid crystal display device of Patent Literature 1, which is of a collimating/diffusing type that collimates light and then diffuses the light, produces a high-quality entirely black image (a wide area colored in black) and a high-quality entirely white image (a wide area colored in white), but cannot control the degree of diffusion of light for each pixel. Accordingly, the visibility of other general images cannot be improved. Another disadvantage of the liquid crystal display device of Patent Literature 1 is a larger thickness than those of Examples 1 to 4.

### REFERENCE SIGNS LIST

111, 211, 311, 411, 511, 611: First polarizer
112, 212, 312, 412, 512, 612: First birefringent layer (First-type birefringent layer)
113, 213: Liquid crystal display panel (PDLC type)
114, 214, 314, 414, 514, 614: Second birefringent layer (First-type birefringent layer)
115, 215, 315, 415, 515, 615: Second polarizer
116, 216, 316, 416: Collimating element
117, 217, 317, 417, 517: Backlight unit
121, 221, 321, 421, 521, 621: TFT substrate
122, 222, 322, 422, 522, 622: Color filter substrate
123, 223, 323, 423, 523, 623: Liquid crystal layer
218: Third birefringent layer (Second-type birefringent layer)
313, 413, 513, 613: Liquid crystal display panel (VA type)
419: Diffusor film

1. A liquid crystal display device comprising:
a collimating backlight unit; and
a liquid crystal display panel,
the liquid crystal display panel comprising:
a pair of substrates; and
a liquid crystal layer disposed between the substrates,
the liquid crystal layer comprising a polymer dispersed liquid crystal.

2. The liquid crystal display device according to claim 1,
wherein each of the substrates includes an alignment film on a surface facing the liquid crystal layer.

3. The liquid crystal display device according to claim 1,
wherein each of the substrates includes a polarizing plate on a surface opposite to the surface facing the liquid crystal layer.

4. The liquid crystal display device according to claim 3,
wherein one of the polarizing plates comprises a first polarizer, and the other comprises a second polarizer,
the liquid crystal display device further comprises a first birefringent layer between the first polarizer and the liquid crystal display panel, and a second birefringent layer between the liquid crystal display panel and the second polarizer, and
both the first birefringent layer and the second birefringent layer have a biaxial parameter NZ of not less than 1.

5. The liquid crystal display device according to claim 4,
wherein the liquid crystal display device further comprises a third birefringent layer between the first polarizer and the first birefringent layer, and
the third birefringent layer has a biaxial parameter NZ of not more than 0.
